(19) United States
(12) Patent Application Publication
(10) Pub. No.: US 2013/0073706 A1
(43) Pub. Date: Mar. 21, 2013

(54) NETWORK MANAGEMENT SYSTEM, AND NETWORK DEVICE

(71) Applicants: Tomoyuki Iijima, Tokyo (JP); Hidemitsu Higuchi, Ebina (JP)

(72) Inventors: Tomoyuki Iijima, Tokyo (JP); Hidemitsu Higuchi, Ebina (JP)

(73) Assignee: ALAXALA Networks Corporation

(21) Appl. No.: 13/572,947

(22) Filed: Aug. 13, 2012

(30) Foreign Application Priority Data
Sep. 15, 2011 (JP) 2011-201671

(51) Int. Cl. G06F 15/173

(52) U.S. Cl. 709/223

(57) ABSTRACT

There are provided a virtual network management system and a network device that can identify the topology of a virtual network, estimate a virtual network to which various computing devices belong and the locations of the computing devices, and present the virtual network and the locations to a network administrator. In a network management device, the configurations of packet transmission devices and a MAC learning table are managed. A virtual network to which given virtual computing units are connected is identified from information about a virtual packet transmission device identifier, a VLAN identifier, a MAC address, and a packet transmission port number acquired from the MAC learning table. The locations of the virtual computing units in the virtual network are estimated, and the topology is drawn on the screen of a display.

### CLAIM OF PRIORITY

The present application claims priority from Japanese Patent Application JP2011-201671 filed on Sep. 15, 2011, the content of which is hereby incorporated by reference into this application.

### BACKGROUND OF THE INVENTION

1. Field of the Invention

The present invention relates to a network management technique, and more particularly to a virtual network management system and a management device of the same.

2. Description of the Related Arts

Heretofore, a single packet transmission device is often operated as a single physical packet transmission device. In these years, such a form is increasing, in which a single packet transmission device is virtually operated as a plurality of devices according to a VR (Virtual Router) technique that a single packet transmission device is virtually divided into a plurality of regions and a VRF (Virtual Routing and Forwarding) technique that a plurality of routing tables are virtually operated in a single packet transmission device. The purpose to operate a single packet transmission device as described above is that devices are coupled to each other to construct a plurality of virtual networks on a single physical network. With this constriction, a single physical network can be used for a plurality of purposes. For example, a single physical network can be shared among a plurality of companies while maintaining closeness (see Japanese Patent Application Laid-Open Publication No. 2011-61401 and U.S. Pat. No. 6,516,345).

On the other hand, virtualization is advancing also in an environment in which computing devices are operated. Such a form is increasing, in which a plurality of computing devices are virtually operated in a single computing device. A virtually created computing device can be easily created and removed more than a physical computing device is, and a virtual computing device can also be moved from a physical computing device to another physical computing device according to the CPU use rate of the computing device and a network load.

### BRIEF SUMMARY OF THE INVENTION

Presently, such a form is increasing, in which the virtualization techniques described above are combined to construct a large-scale virtual network. However, the virtually constructed network has drawbacks that the network topology deviates from the physical network topology and an administrator is difficult to grasp the topology. For example, suppose that a physical network is virtually divided into two networks and two virtual computing devices are operated on a physical computing device. In this case, it is difficult to determine whether which one of the virtual computing devices is connected to which one of the virtual networks by confirming only physical wiring. Moreover, when it is desired to identify the location of a virtual computing device by its IP address, a plurality of computing devices sometimes use the same IP address if IP addresses are virtualized by a virtualization technique. Thus, it is difficult to grasp the location of the computing device.

Packet transmission devices in these years exchange an LLDP (Link Layer Discovery Protocol) between packet transmission devices to confirm their locations. It is also possible to solve the problems by forcing computing devices to use the protocol. However, computing devices generally do not support the protocol, and there is also a limitation to force the computing device to use the protocol intended for the packet transmission device.

There is a course of action that a single management system implements the operation and management of both of the network and the computing device. However, operation and management interfaces are different between the network and the computing device, and it is necessary that different types of operations and management devices coexist with each other, causing a difficulty in mounting.

It is necessary to provide a network management system or a management computing device that can identify the topology of a virtually constructed network and the location of a virtually operating computing device in the network only using information of a packet transmission device with no constraints on the computing device.

It is an object of the present invention to provide a virtual network management system and a management device that can address the problems, identify the topology of a virtual network, estimate a virtual network to which a computing device belongs and the location of the computing device, and present the virtual network and the location to a network administrator.

In order to achieve the object, the present invention provides a network management system of a network connected with a plurality of packet transmission devices that construct a virtual network and a plurality of physical computing devices that operate a virtual computing unit. The network management system includes a network management unit and a display. The network management unit collects information from the packet transmission devices, estimates the virtual network to which the virtual computing unit is connected and a location of the computing device in the virtual network based on the collected information, and displays a topology of the virtual network and the virtual computing unit connected to the virtual network on the display.

Moreover, in order to achieve the object, the present invention provides a network management device that manages a network connected with a plurality of packet transmission devices that construct a virtual network and a plurality of physical computing devices that operate a virtual computing unit. The network management device includes a processing unit and a storage unit. The processing unit collects information from the packet transmission devices, estimates the virtual network to which the virtual computing unit is connected and a location of the computing device in the virtual network based on the collected information, and outputs a topology of the virtual network and the location of the virtual computing unit connected to the virtual network.

According to an aspect of the present invention, it is possible to identify the topology of a virtual network, estimate a virtual network to which a virtual computing unit or the like belongs and the location of the virtual computing unit or the like, and present the virtual network and the location to a network administrator.

### BRIEF DESCRIPTION OF THE DRAWINGS

The present invention will become fully understood from the detailed description given hereinafter and the accompanying drawings, wherein:

FIG. 1 is an illustration of the topology of a network management system in which a network management device is connected to a plurality of packet transmission devices in a first embodiment;

FIG. 2 is an illustration of the schematic configuration of a packet transmission device according to the first embodiment;

FIG. 3 is an illustration of the schematic configuration of the network management device according to the first embodiment;

FIG. 4 is a diagram illustrating an exemplary GUI of the network management device according to the first embodiment;

FIG. 5 is a sequence diagram illustrating a process flow when the network management device according to the first embodiment requests the packet transmission device to acquire information;

FIG. 6 is a diagram illustrating an exemplary MAC learning table according to the first embodiment;

FIG. 7 is a diagram illustrating an exemplary virtual network topology table according to the first embodiment;

FIG. 8 is a diagram illustrating an exemplary MAC learning database according to the first embodiment;

FIG. 9 is a diagram illustrating an exemplary converted MAC learning database according to the first embodiment;

FIG. 10 is a flowchart illustrating a process that the network management device identifies a virtual network to which a computing device belongs in embodiments;

FIG. 11 is a flowchart illustrating a process that the network management device according to the first embodiment estimates the location of a computing device;

FIG. 12 is a flowchart illustrating a process that a network management device according to a second embodiment estimates the location of a computing device;

FIG. 13 is an illustration of the schematic configuration of a packet transmission device according to a third embodiment; and

FIG. 14 is a sequence diagram illustrating a process flow when the packet transmission device according to the third embodiment requests another packet transmission device to acquire information.

### DETAILED DESCRIPTION OF THE INVENTION

In the following, first to third embodiments of the present invention will be in turn described with reference to the drawings. It is noted that in the present specification, for example, a plurality of packet transmission devices 10a, 10b, and 10c are sometimes collectively referred to as a packet transmission device 10. Moreover, in the present specification, “a physical computing device” and “a virtual computing unit” are sometimes collectively referred to as “a computing device”.

### First Embodiment

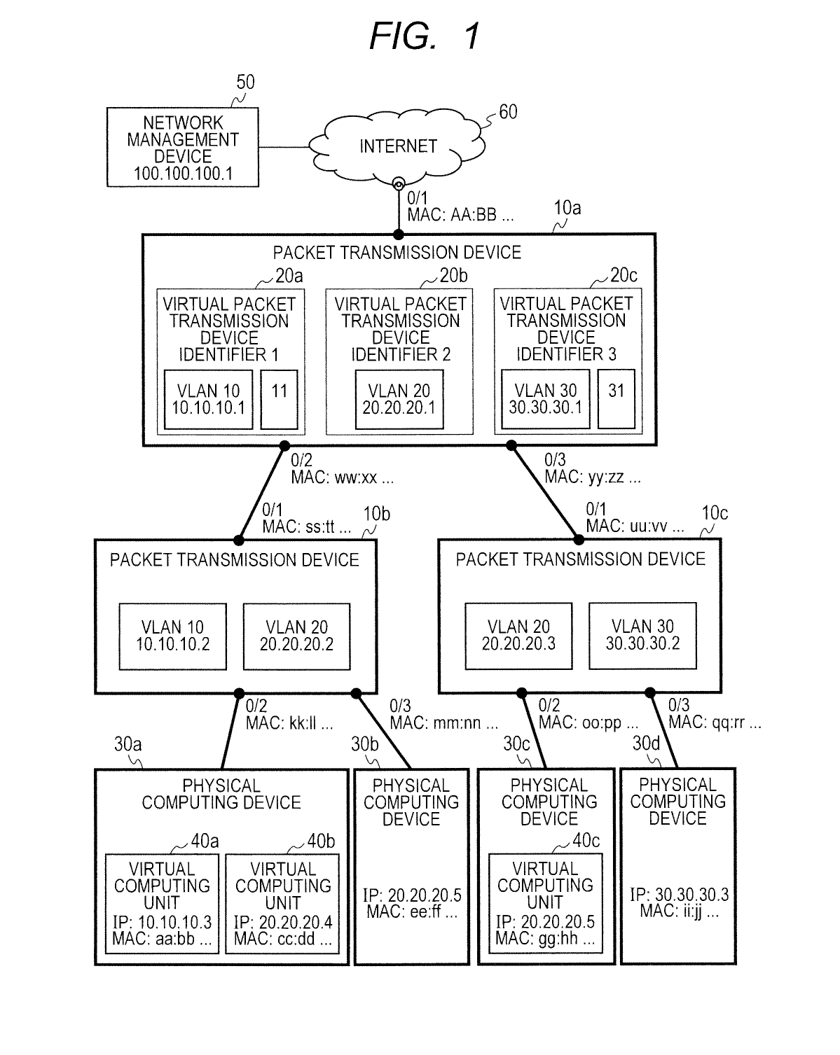

A first embodiment is an exemplary embodiment of a network management system in which a plurality of packet transmission devices are connected to a network management device. In the following, a network topology according to this embodiment, the configuration of the packet transmission device, the configuration of the network management system, procedures to acquire information about the packet transmission device, and procedures to estimate the location of the computing device will be in turn described with reference to FIGS. 1 to 9.

FIG. 1 is a diagram illustrating the network management system according to the first embodiment. A network illustrated in FIG. 1 is formed in which three packet transmission devices 10a, 10b, and 10c, four physical computing devices 30a, 30b, 30c, and 30d, and a network management device 50 are coupled to the Internet 60 through an Ethernet (registered trademark) cable. An IP address is individually allocated to the devices, and the IP address is specified to identify the location of the device.

The packet transmission devices 10a, 10b, and 10c have a function to virtually divide the packet transmission devices 10a, 10b, and 10c themselves into a plurality of devices, or a function to virtually operate a plurality of routing tables. In the packet transmission device 10a, virtual packet transmission devices 20a, 20b, and 20c are operating. When the network management device 50 sets the virtual packet transmission device and looks up information, an identifier to identify the virtual packet transmission device is necessary. In the drawing, identifiers 1, 2, and 3 are allocated to the virtual packet transmission devices 20a, 20b, and 20c, respectively. The network management device 50 specifies the identifier to set a desired virtual packet transmission device and to look up information.

The virtual packet transmission device is operated to virtually construct a plurality of networks on a single physical network. In the case of the drawing, the virtual packet transmission devices 20a, 20b, and 20c construct different virtual networks. In the following, the virtual networks are referred to as a virtual network A, a virtual network B, and a virtual network C.

VLANs (Virtual Local Area Networks) 10 and 11 are established in the virtual network A, to which the packet transmission device 10b is connected. The physical computing device 30a and 30b are connected to the packet transmission device 10b. However, only a virtual computing unit 40a uses the same sub-network with the VLAN 10, and only the virtual computing unit 40a is included in the virtual network A.

A VLAN 20 is established in the virtual network B, to which the packet transmission devices 10b and 10c are connected. The physical computing devices 30a and 30b are connected to the packet transmission device 10b, and the physical computing devices 30c and 30d are connected to the packet transmission device 10c. However, only the physical computing device 30b and virtual computing units 40b and 40c use the same sub-network with the VLAN 20, and these computing devices are included in the virtual network B.

VLANs 30 and 31 are established in the virtual network C, to which the packet transmission device 10c is connected. The physical computing device 30d is connected to the packet transmission device 10c. However, only the physical computing device 30d uses the same sub-network with the VLAN 30, and only the physical computing device 30d is included in the virtual network C.

In the case where the virtual network as described above is constructed, it is difficult to read the topology from physical wiring. Moreover, it is difficult to read a virtual network to which a virtual computing unit is connected and the location of the virtual computing unit from physical wiring.

In the following, in the case where a virtual network is constructed, a network management method will be described in detail which can identify the network topology of the virtual network and can estimate and present a virtual network to which various computing devices belongs and the location of the computing device to a network administrator.

It is noted that the topology of the network, the number of the virtual packet transmission devices 20 in the packet transmission device 10, and the number of the virtual computing units 40 in the physical computing device 30 are not limited to examples illustrated in FIG. 1, and can be appropriately modified and altered to make other forms.

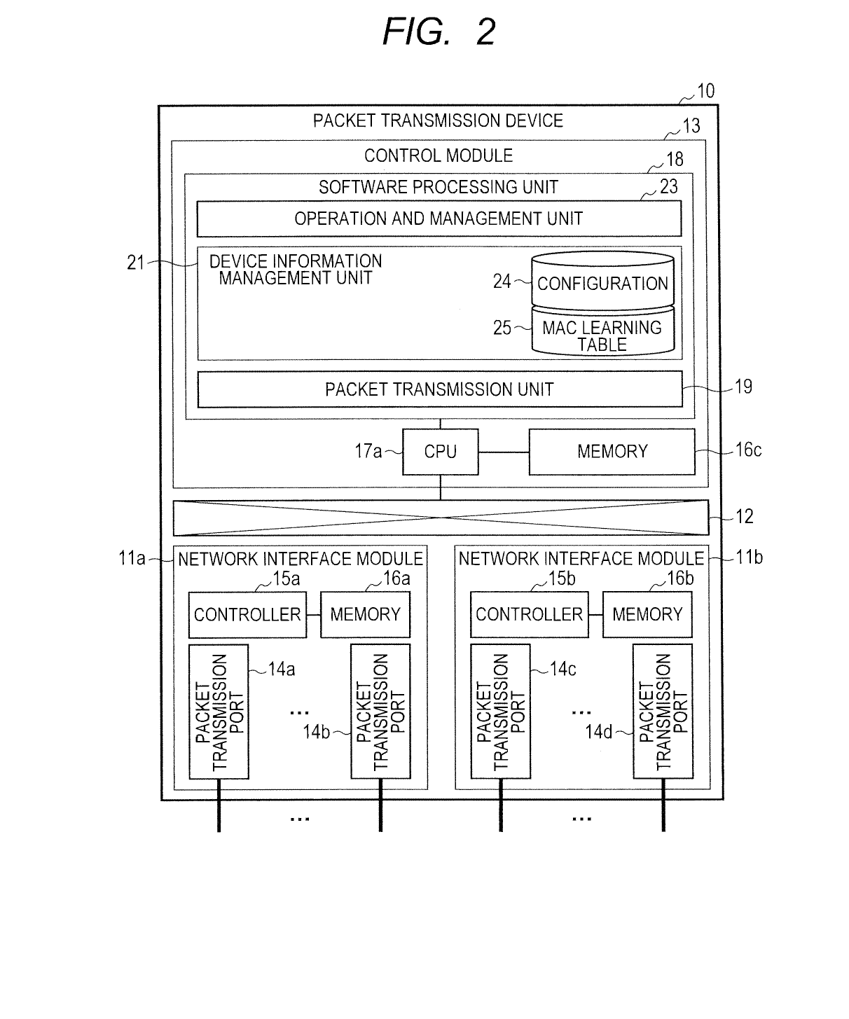

FIG. 2 is a diagram illustrating the schematic configuration of the packet transmission device 10 according to the first embodiment. The configuration of the packet transmission device 10 corresponding to the packet transmission devices 10a, 10b, and 10c in FIG. 1 includes a plurality of network interface modules 11a and 11b, a switching module 12, and a control module 13.

The network interface modules 11a and 11b include pluralities of packet transmission ports 14a, 14b, 14c, and 14d, controllers 15a and 15b, and memories 16a and 16b. The Ethernet cable is physically connected to the packet transmission ports 14. The controllers 15 analyze a packet received from the packet transmission ports 14, and identify the destination of the packet. In the case where the destination is addressed to a different device, the controller 15 identifies a destination network interface module 11 and a destination packet transmission port 14, and transfers the packet to the switching module 12. On the other hand, in the case where the destination of a packet is addressed to the device of the controller 15 itself, the controller 15 identifies the control module 13 for the destination, and transfers the packet to the switching module 12.

In performing the processing, in order to grasp which device sends a packet, the network interface module 11 records a source MAC (Media Access Control) address described in the packet together with a transmission port number at which the packet is received. The memories 16a and 16b function as a buffer in which a packet transmitted through the packet transmission port 14 is temporarily stored.

The switching module 12 is a switch that receives a packet and sends the packet to the network interface module 11 or the control module 13 according to an instruction made by the controller 15.

The control module 13 includes a memory 16c and a CPU (Central Processing Unit) 17a. The memory 16c stores various programs for a software processing unit 18. The CPU 17 runs a stored program to function as the software processing unit 18.

The software processing unit 18 includes a packet transmission unit 19, a device information management unit 21, and an operation and management unit 23. The packet transmission unit 19 is responsible for receiving a packet addressed to the device of the packet transmission unit 19 itself and sending a packet addressed to a different device that is created in the software processing unit 18. In the case where the packet transmission unit 19 receives a packet addressed to the device of the packet transmission unit 19 itself and the packet is a request for making settings and looking up information sent from the network management device 50 illustrated in FIG. 1, the packet transmission unit 19 sends the packet to the operation and management unit 23. On the other hand, in the case where the packet transmission unit 19 receives a packet from the inside of the software processing unit 18 and the packet is sent from the operation and management unit 23, the packet transmission unit 19 sends the packet to a desired network management device 50.

When the operation and management unit 23 receives the request for making settings and looking up information sent from the network management device 50 through the packet transmission unit 19, the operation and management unit 23 analyzes the received request for making settings and looking up information. The content of the request for making settings and looking up information includes various items related to the operation of the operation and management unit 23 such as the creation and deletion of a virtual region and the information look up of the VLAN, for example. When the operation and management unit 23 analyzes the request for making settings and looking up information, the operation and management unit 23 requests the device information management unit 21 to make settings and look up information.

The device information management unit 21 includes a configuration 24 and a MAC learning table 25 therein. The configuration 24 is recorded with the settings and status information of the entire packet transmission device. For example, the configuration 24 is recorded with the settings and status information of the virtual packet transmission devices operating in the packet transmission device 10 and the settings and status information of the VLANs. Moreover, the MAC learning table 25 is recorded with a source MAC address learned at the network interface module 11 together with a packet transmission port number. For example, in the case of the packet transmission device 10b, a MAC address “cc:dd . . . ” of the virtual computing unit 40b is recorded together with a packet transmission port number “0/2”. The device information management unit 21 sets and looks up the configuration 24 and the MAC learning table 25 based on the request for making settings and looking up information requested by the operation and management unit 23, and returns the result to the operation and management unit 23. It is noted that in the present specification, the configuration and the MAC learning table mean the recording area of information or information itself recorded in the storage areas as illustrated in FIG. 2.

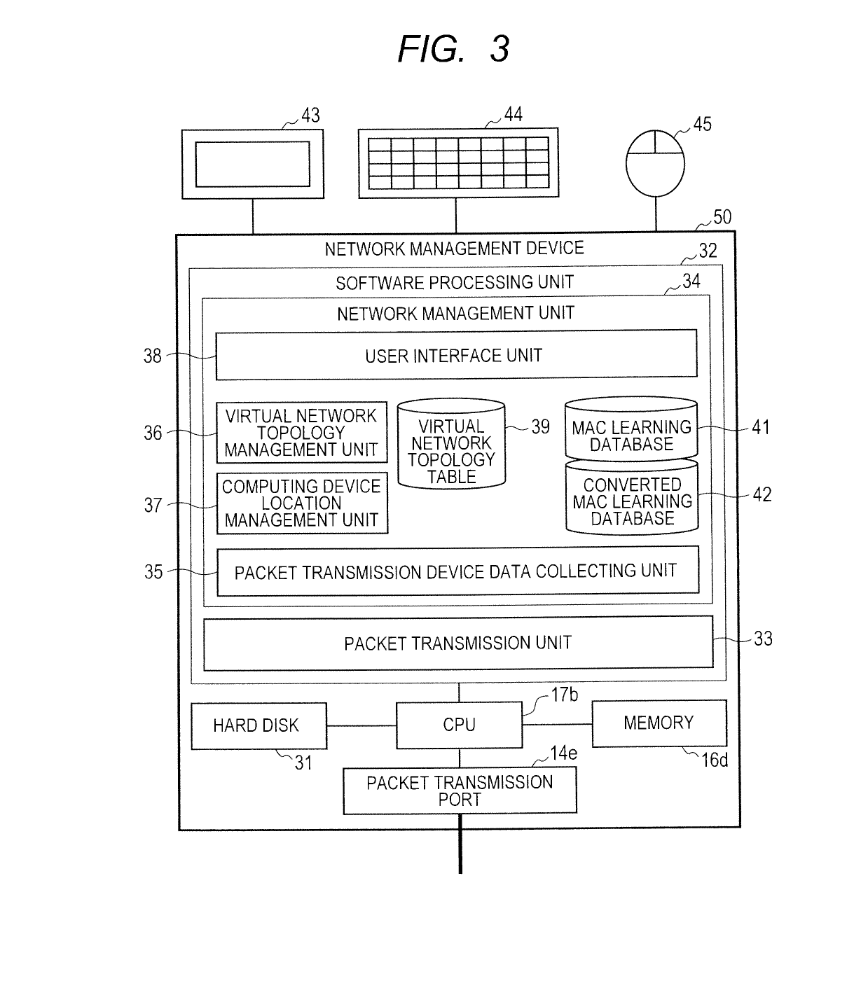

FIG. 3 is a diagram illustrating the schematic configuration of the network management device 50 according to the first embodiment. The network management device 50 is operated on a multipurpose computer, and includes a packet transmission port 14e, a hard disk 31, a memory 16d, a CPU 17b, and the like. The hard disk 31 stores the program of a software processing unit 32. The CPU 17b is a processing unit that runs the program to function as the software processing unit 32, that is, a packet transmission unit 33 and a network management unit 34. The packet transmission unit 33 is responsible for transmitting packets through the packet transmission port 14e. A display 43, a keyboard 44, and a mouse 45 belong to the network management device 50.

The network management unit 34 is an application that operates as a front end to manage the packet transmission device 10, including a packet transmission device data collecting unit 35, a virtual network topology management unit 36, a computing device location management unit 37, a user interface unit 38, a virtual network topology table 39, a MAC learning database 41, and a converted MAC learning database 42. It is noted that the virtual network topology table 39, the MAC learning database 41, and the converted MAC learning database 42 are accumulated and stored in the memory 16d that is a storage unit.

The packet transmission device data collecting unit 35 creates an information acquisition request message according to a request from the virtual network topology management unit 36 and the computing device location management unit 37, and sends the message to the packet transmission device 10. The content of the information acquisition request is information such as the configuration of the packet transmission device and the MAC address learned by the packet transmission device, for example. The detail of the process for acquiring information will be described later. When the packet transmission device data collecting unit 35 acquires a desired item of information, the packet transmission device data collecting unit 35 transfers the information to the virtual network topology management unit 36 or the computing device location management unit 37 that is a request source.

The virtual network topology management unit 36 extracts information about the topology of a virtual network from the configurations of the packet transmission devices obtained through the packet transmission device data collecting unit 35, and creates a virtual network topology table 39. This virtual network topology table 39 finds the connection relationship between the entire virtual networks, and the topology can be identified. The detail of the identification process will be described later. The user interface unit 38 can present the identified topologies of the virtual networks using the display 43, for example. Thus, the network administrator can confirm the topologies of the virtual networks.

On the other hand, the computing device location management unit 37 acquires the MAC learning table 25 of the entire packet transmission devices that are management subjects as transfer history information through the packet transmission device data collecting unit 35, and creates a MAC learning database 41. Moreover, the computing device location management unit 37 creates a converted MAC learning database 42 that the content of the MAC learning database 41 having transfer history information recorded therein is sorted for every packet transmission port. These items of information enable the identification of computing devices connected to the virtual networks and the estimation of the locations of the computing devices. The detail of the estimation process will be described later. The user interface unit 38 can present the estimated locations of the computing devices using the display 43, for example. Thus, the network administrator can confirm the locations of the computing devices connected to the virtual networks.

The user interface unit 38 displays a GUI (Graphical User Interface) for managing the packet transmission device on the display 43, and accepts various instructions from the network administrator manipulating the keyboard 44 and the mouse 45.

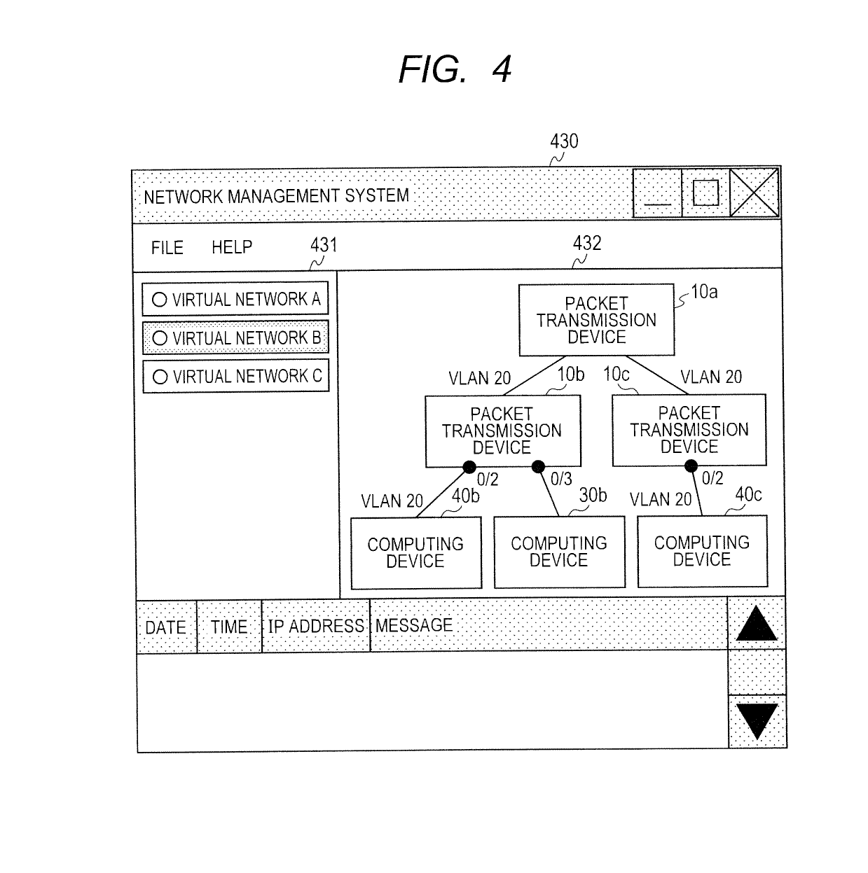

FIG. 4 is a diagram illustrating a network management system that is an exemplary GUI displayed on the display 43 of the network management device 50 according to the first embodiment. The entire virtual networks that the network management device 50 manages are displayed in a list on a left pane 431 of a GUI 430 of the network management system. The topology of a virtual network (a network topology) selected on the left pane 431 is drawn with icons expressing the packet transmission devices 10, the computing devices 30 and 40, and Ethernet lines on a right pane 432.

In the case of FIG. 4, on the left pane 431, the virtual network B is selected. As a result of estimating the topology by the network management device 50, such a topology is displayed on the right pane 432 in which the packet transmission device 10a is connected to the packet transmission device 10b and the packet transmission device 10c through the VLAN 20, the physical computing devices 30a and 40b are connected to the forward side of the packet transmission device 10b, and the physical computing device 40c are connected to the forward side of the packet transmission device 10c. The detail of the estimation process will be described later.

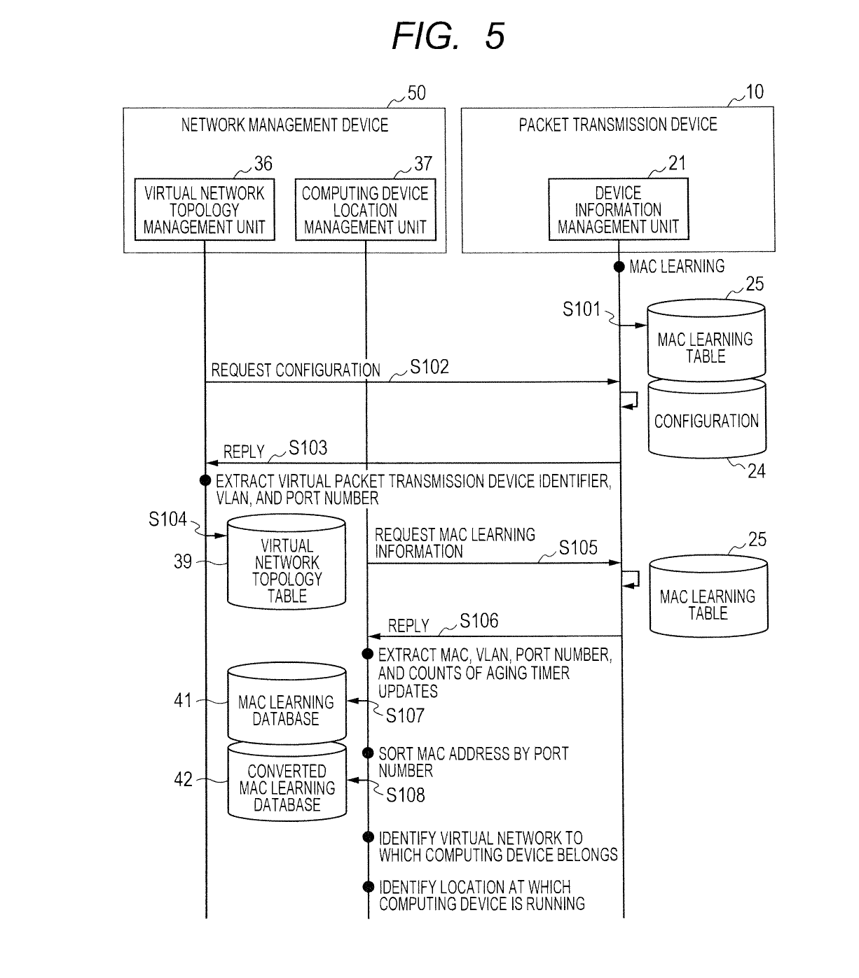

FIG. 5 is a sequence diagram illustrating a process flow when the network management device 50 requests the packet transmission device 10 to acquire information in this embodiment. When the packet transmission devices 10 receive a packet, the packet transmission devices 10 look up the source MAC address of the packet, and record the source MAC address on the MAC learning table 25 together with a packet transmission port number at which the packet is received.

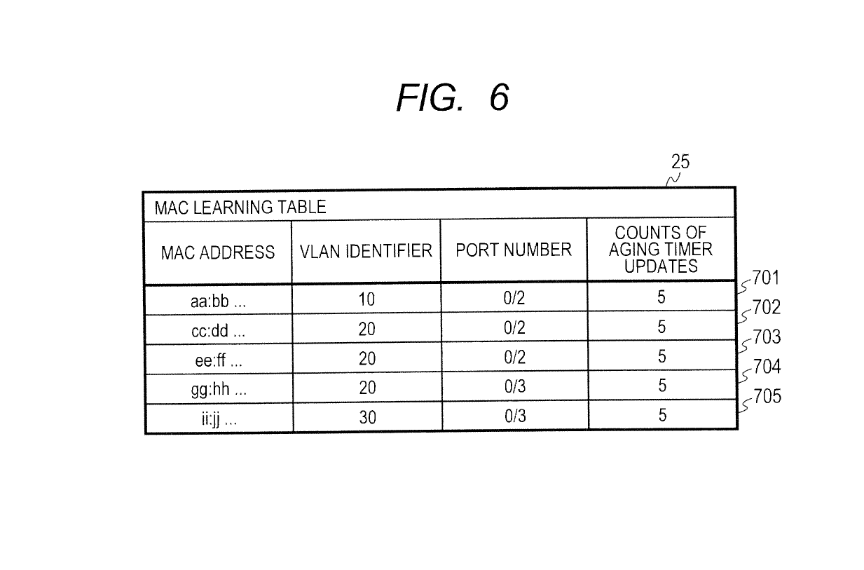

FIG. 6 is a diagram illustrating the MAC learning table 25 of the packet transmission device 10a. Entries 701 to 705 are illustrated. Numeral signs in the table show entries similarly in other tables. In the case of FIG. 5, it is shown from the entry 701 that a packet having a source MAC address “aa:bb . . . ” is received at a packet transmission port number “0/2”. In the topology in FIG. 1, the MAC address “aa:bb . . . ” expresses that the source is the virtual computing unit 40a.

In this reception, the packet transmission device 10 records a VLAN identifier associated with the packet transmission port number as additional information. Moreover, the packet transmission device 10 updates an aging timer (time to delete a MAC address from the memory) every time when learning a MAC address, and also records the counts of aging timer updates within a predetermined time period as additional information. In the case of FIG. 6, the device information management unit 21 records a VLAN identifier “10” and a count of aging timer updates “5” as additional information on the entry 701 in the MAC learning table 25 (Step S101 in FIG. 5).

As illustrated in FIG. 5, the virtual network topology management unit 36 in the network management device 50 issues an acquisition request for configuration information to the packet transmission device 10 at regular time intervals (Step S102). The acquisition request is delivered to the device information management unit 21 in the packet transmission device 10. The device information management unit 21 creates a message in which the content of the configuration 24 is described, and sends a reply to the network management device 50 (Step S103).

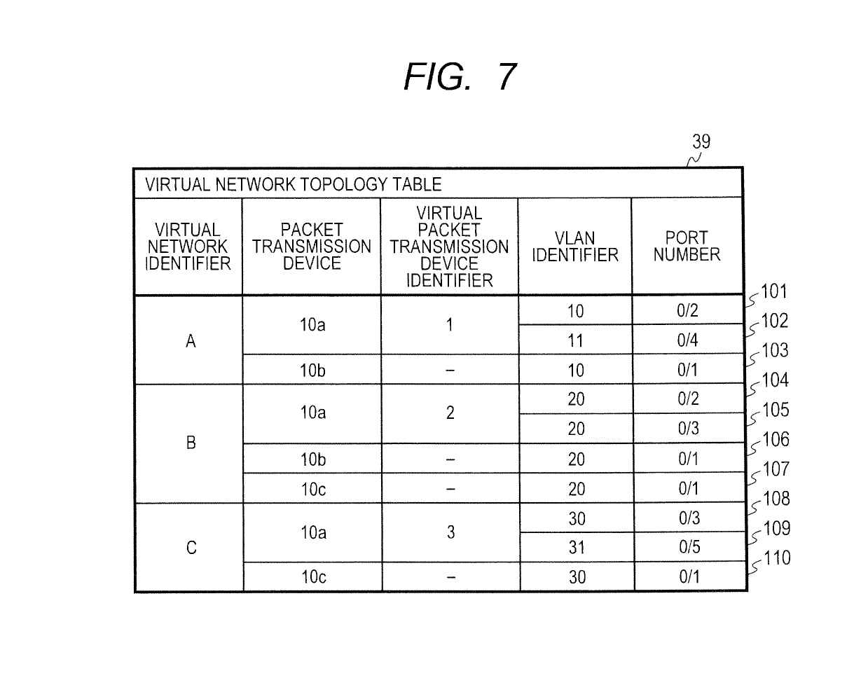

When the virtual network topology management unit 36 receives the configuration of the packet transmission device from the reply, the virtual network topology management unit 36 extracts information about a virtual packet transmission device identifier, a VLAN identifier, and a packet transmission port number from the configuration, and writes the information on the virtual network topology table (Step S104). FIG. 7 is a diagram illustrating a created virtual network topology table 39. As apparent from the drawing, in the virtual network topology table 39, entries 101 to 110 are recorded corresponding to virtual network identifiers A, B, and C.

The computing device location management unit 37 in the network management device 50 also issues an acquisition request for the MAC learning table 25 to the packet transmission device 10 through the packet transmission device information acquiring unit 35 at regular time intervals (Step S105). The acquisition request is delivered to the device information management unit 21 in the packet transmission device 10. The device information management unit 21 creates a message in which the content of the MAC learning table 25 is described, and sends a reply to the network management device 50 (Step S106).

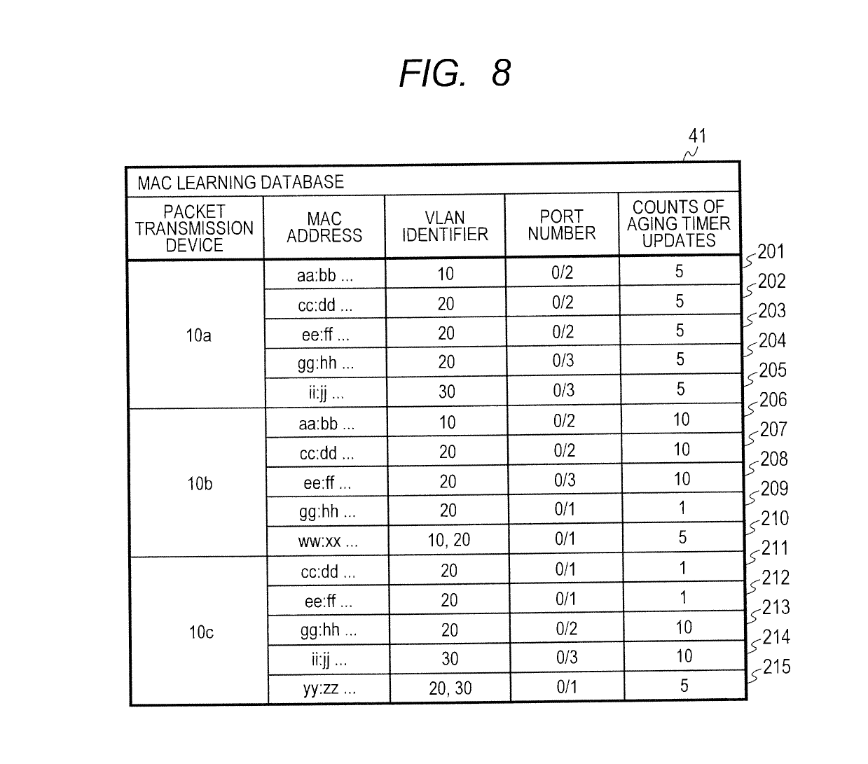

When the computing device location management unit 37 receives information about the MAC learning table 25 from the reply, the computing device location management unit 37 extracts a MAC address, a packet transmission port number at which the MAC address is learned, a VLAN identifier associated with the packet transmission port, and a count of aging timer updates from the information, and writes them on the MAC learning database 41 (Step S107). FIG. 8 is a diagram illustrating a created MAC learning database 41. In FIG. 8, in the MAC learning database 41, entries 201 to 215 are recorded corresponding to the packet transmission devices 10a, 10b, and 10c.

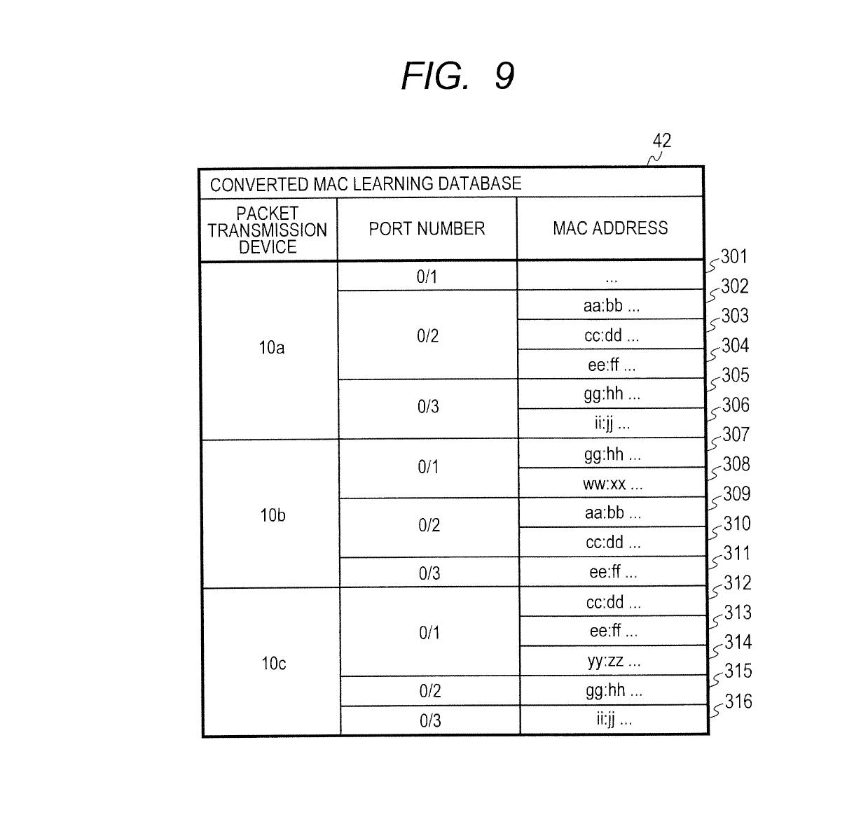

Moreover, the computing device location management unit 37 creates a converted MAC learning database 42 in which the MAC learning database 41 in FIG. 8 is sorted by every packet transmission port of the packet transmission devices 10 (Step S108). FIG. 9 is a diagram illustrating the created converted MAC learning database 42. Entries 301 to 316 are recorded corresponding to the port numbers of the packet transmission devices 10a, 10b, and 10c. The computing device location management unit 37 in the network management device 50 looks up the virtual network topology table 39 in FIG. 7, the MAC learning database 41 in FIG. 8, and the converted MAC learning database 42 in FIG. 9 to estimate a virtual network to which a computing device belongs and the location of the computing device in the virtual network. The detail of the estimation process will be described later.

As described above, the procedures to acquire information about the packet transmission device 10 by the network management device 50 are described. Subsequently, based on the acquired information, the procedures to identify the topology of a virtual network and estimate the location of the computing device in the virtual network by the network management device 50 according to this embodiment will be described.

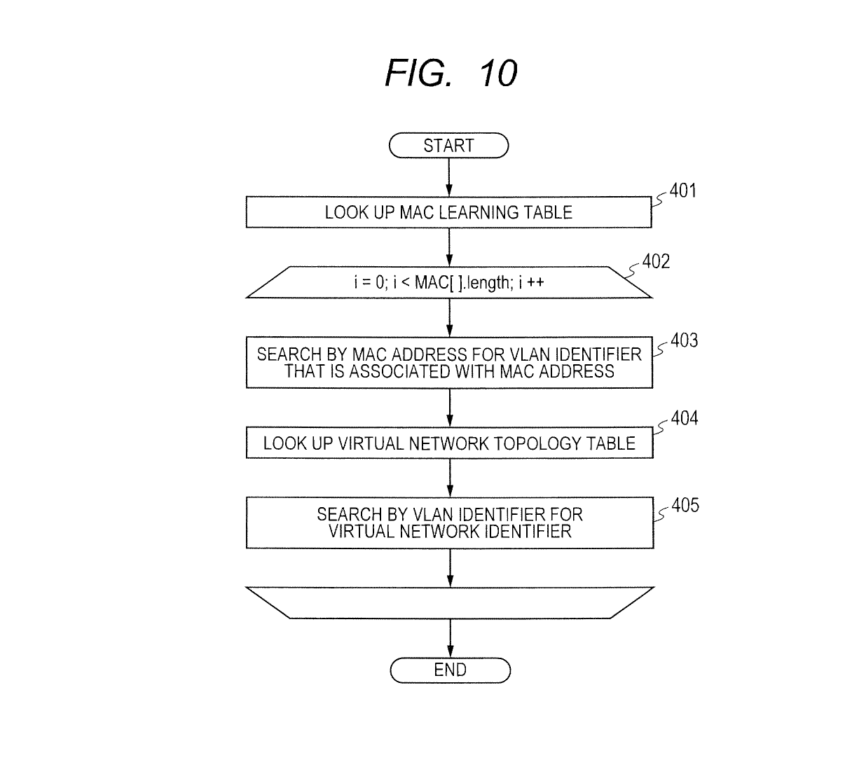

FIG. 10 is a flowchart that the computing device location management unit 37 in the network management device 50 according to the first embodiment identifies the virtual network to which the computing device belongs. The computing device location management unit 37 first looks up the MAC learning database 41 in FIG. 8 (401), and acquires VLAN identifiers described together with MAC addresses (403). The computing device location management unit 37 looks up the virtual network topology table 39 in FIG. 7 using the acquired VLAN identifiers as keys (404), and acquires virtual network identifiers associated with the VLAN identifiers (405).

For example, the computing device location management unit 37 looks up the MAC learning database 41 in FIG. 8. In the case of the configuration in FIG. 1, the computing device location management unit 37 learns the entry of the

MAC address “cc:dd . . . ” of the virtual computing unit 40b, and then finds that the VLAN identifier associated with the MAC address is “20” (entries 202, 207, and 211). The computing device location management unit 37 looks up the virtual network topology table 39 in FIG. 7 using this VLAN identifier “20” as a key, and then finds that the virtual network identifier associated with the VLAN identifier “20” is the virtual network “B” (entries 104 to 107). Thus, it can be identified that the computing device having the MAC address “cc:dd . . . ” belongs to the virtual network B.

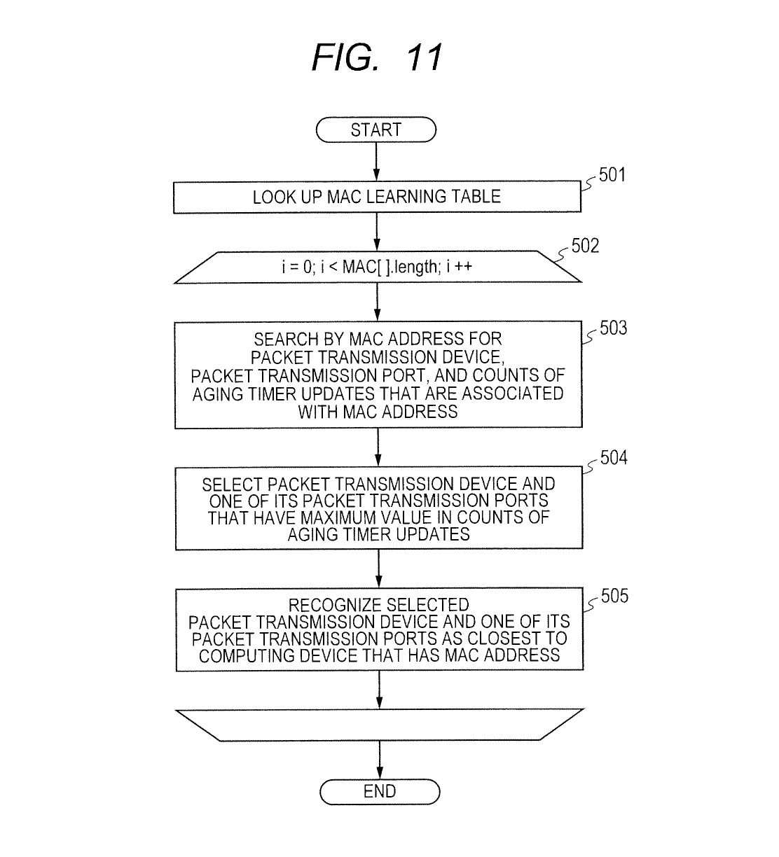

Next, FIG. 11 is a flowchart that the computing device location management unit 37 in the network management device 50 estimates the location of the computing device. The computing device location management unit 37 looks up the MAC learning database 41 in FIG. 8 (501), and acquires the combination of a packet transmission device name, a packet transmission port number, and a count of aging timer updates described together with the MAC addresses (503). The computing device location management unit 37 according to this embodiment selects a packet transmission device name and a packet transmission port number with the largest count of aging timer updates (504), and estimates the packet transmission device as the packet transmission device the closest to the computing device (505).

For example, when the computing device location management unit 37 looks up the MAC learning database 41 in FIG. 8 and learns the entry of the MAC address “cc:dd . . . ”, the combination of the packet transmission device that learns the MAC address, the packet transmission port number, and the counts of aging timer updates is three combinations below. The first combination is the combination of the packet transmission device 10a, the packet transmission port number “0/2”, and a count of aging timer updates 5 (the entry 202).

The second combination is the combination of the packet transmission device 10b, the packet transmission port number “0/2”, and a count of aging timer updates 10 (the entry 207). The third combination is the combination of the packet transmission device 10c, a packet transmission port number “0/1”, and a count of aging timer updates 1 (the entry 211).

Among the combinations, it can be said that the packet transmission device having the packet transmission port with the largest count of aging timer updates is the closest to the computing device having the MAC address “cc:dd . . . ”. Therefore, it is estimated that the virtual computing unit 40b having the MAC address “cc:dd . . . ” is the closest to the packet transmission port number “0/2” of the packet transmission device 10b in which the aging timer of the MAC address is updated for ten times.

From the processes illustrated in FIGS. 10 and 11, it can be identified that the virtual computing unit having the MAC address “cc:dd . . . ” belongs to the virtual network B, and it can be estimated that the virtual computing unit having the MAC address “cc:dd . . . ” exists on the forward side of the packet transmission port number “0/2”. The computing device location management unit 37 controls the user interface unit to draw the location of the computing device on the display 43 based on this information, so that the network administrator can easily confirm the location of the computing device in the virtual network.

In this embodiment, it is possible to identify the topology of a virtual network, and it is possible to estimate the location of the computing device in the virtual network. Thus, when a loop occurs in a certain virtual network, for example, it is possible to confirm the topology of the virtual network in which the loop occurs and to confirm a computing device that will be subject to the influence of the loop. Since the computing device can be confirmed, it is also possible to notify the network administrator of an alarm as well as a user of the computing device.

It is noted that the procedures to estimate the location of the computing device are described as the virtual computing unit 40b having the MAC address “cc:dd . . . ” is taken as an example. However, it is possible to similarly estimate the locations of the computing devices in the virtual computing unit 40c having a MAC address “gg:hh . . . ”, the physical computing device 30b having a MAC address “ee:ff . . . ”, and the like.

### Second Embodiment

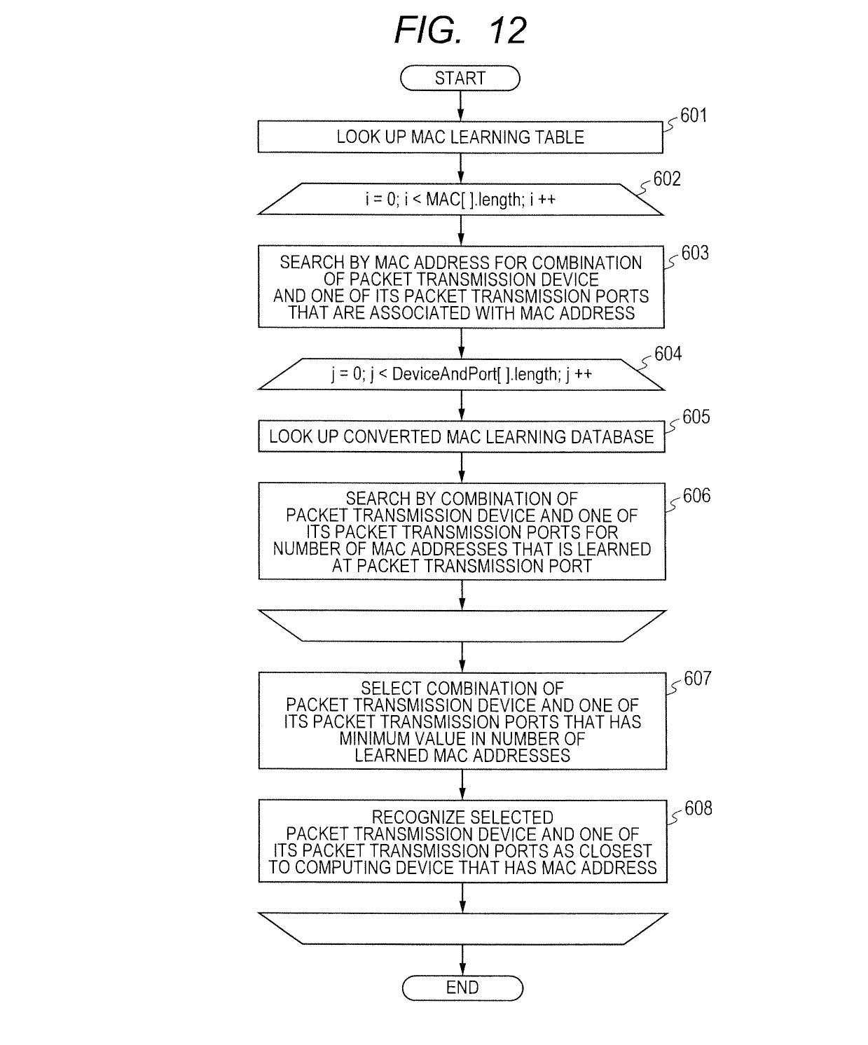

Next, a virtual network management system according to a second embodiment will be described with reference to FIGS. 10 and 12. FIG. 10 is a flowchart illustrating a flow that the computing device location management unit 37 in the network management device 50 identifies the virtual network to which a computing device belongs as described in the first embodiment.

The computing device location management unit 37 first looks up the MAC learning database 41 in FIG. 8 (401), and acquires VLAN identifiers described together with MAC addresses (403). The computing device location management unit 37 looks up the virtual network topology table 39 in FIG. 7 using the acquired VLAN identifiers as keys (404), and acquires virtual network identifiers associated with the VLAN identifiers (405).

For example, the computing device location management unit 37 looks up the MAC learning database 41 in FIG. 8 and learns the entry of a MAC address “cc:dd . . . ”, and then finds that the VLAN identifier associated with the MAC address is “20” (202, 207, and 211). The computing device location management unit 37 looks up the virtual network topology table 39 in FIG. 7 using this VLAN identifier as a key, and then finds that the virtual network identifier associated with the VLAN identifier “20” is the virtual network “B” (104 to 107). Thus, it can be identified that the computing device having the MAC address “cc:dd . . . ” belongs to the virtual network B.

FIG. 12 is a flowchart illustrating a flow that a computing device location management unit 37 in a network management device 50 according to the second embodiment estimates the location of a computing device. In the case of this embodiment, the computing device location management unit 37 looks up the MAC learning database 41 in FIG. 8 (601), and acquires the combination of a packet transmission device name and a packet transmission port number described together with individual MAC addresses (603).

The computing device location management unit 37 specifies the combination of the acquired packet transmission device name and the packet transmission port number to look up the converted MAC learning database 42 in FIG. 9 (605), and acquires the number of the MAC addresses learned at the packet transmission port number (606). The computing device location management unit 37 selects the combination of the packet transmission device name with the smallest number of the learned MAC addresses and the packet transmission port number (607), and estimates the packet transmission device as a packet transmission device the closest to the computing device (608).

For example, when the computing device location management unit 37 looks up the MAC learning database 41 in FIG. 8 and learns the entry of the MAC address “cc:dd . . . ”, the combination of the packet transmission device name that learns the MAC address and the packet transmission port number is three combinations below. The first combination is the combination of the packet transmission port number “0/2” and the packet transmission device 10a (202). The second combination is the combination of the packet transmission port number “0/2” and the packet transmission device 10 (207). The third combination is the combination of the packet transmission port number “0/1” and the packet transmission device 10c (211). When the computing device location management unit 37 specifies these combinations to look up the converted MAC learning database 42 in FIG. 9, the number of the MAC addresses learned at the packet transmission ports is as follows.

As a result of receiving packets from the virtual computing unit 40a, the virtual computing unit 40b, and the physical computing device 30b, three MAC addresses are learned at the packet transmission port number “0/2” of the packet transmission device 10a (302, 303, and 304). As a result of receiving packets from the virtual computing unit 40a and the virtual computing unit 40b, two MAC addresses are learned at the packet transmission port number “0/2” of the packet transmission device 10b (310 and 311). As a result of receiving packets from the virtual computing unit 40b, the physical computing device 30b, and the packet transmission device 10a, three MAC addresses are learned at the packet transmission port number “0/1” of the packet transmission device 10c (312, 313, and 314). The reason why the MAC address of the packet transmission device 10a is learned is that a packet sent from a device that belongs to a sub-network different from a sub-network to which the packet transmission device 10c belongs reaches the packet transmission device 10a and is routed, and as the consequence, the packet reaches the packet transmission device 10c.

Among the combinations, it can be said that the packet transmission device having the packet transmission port with the smallest number of the learned MAC addresses is the closest to the computing device having the MAC address “cc:dd . . . ”. Therefore, it is estimated that the virtual computing unit 40b having the MAC address “cc:dd . . . ” is the closest to the packet transmission port number “0/2” of the packet transmission device 10b that learns two MAC addresses.

In the second embodiment, the processes illustrated in FIGS. 10 and 12 can identify that the computing device having the MAC address “cc:dd . . . ” belongs to the virtual network B, and it can be estimated that the computing device exists on the forward side of the packet transmission port number “0/2” of the packet transmission device 10b. The computing device location management unit 37 draws the location of the computing device on the display 43 based on this information, so that the network administrator can easily confirm the location of the computing device in the virtual network.

It is possible to identify the topology of a virtual network, and it is possible to estimate the location of a computing device in the virtual network. Thus, when a loop occurs in a certain virtual network, for example, it is possible to confirm the topology of the virtual network in which the loop occurs, and it is possible to confirm a computing device that will be subject to the influence of the loop. Since the computing device can be confirmed, it is also possible to notify the network administrator of an alarm as well as a user of the computing device.

### Third Embodiment

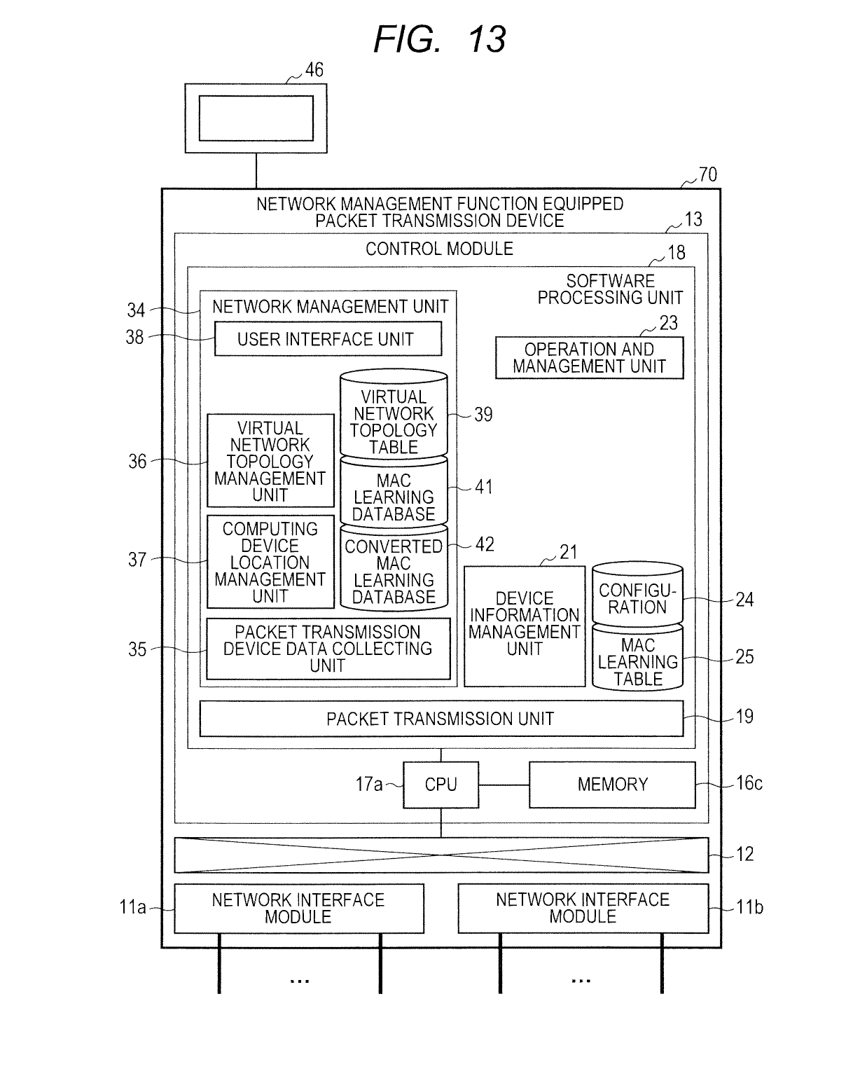

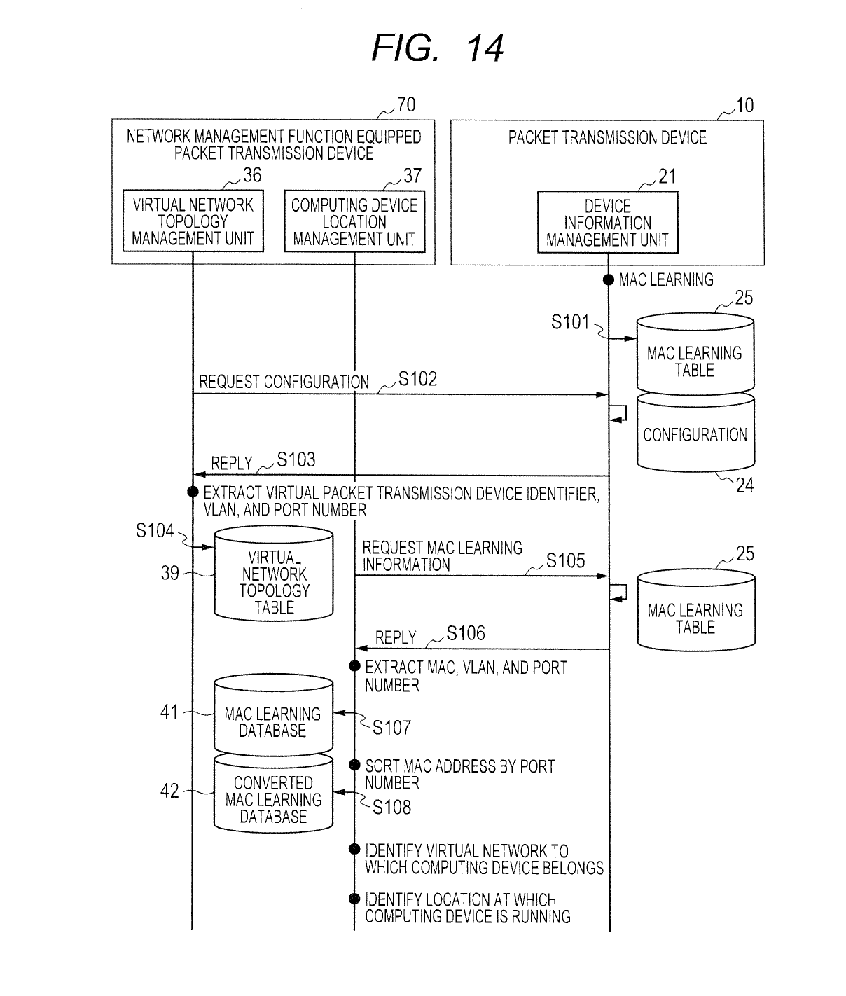

Next, an embodiment of a virtual network management system using a packet transmission device equipped with a network management function according to a third embodiment will be described with reference to FIGS. 13 and 14. FIG. 13 is a diagram illustrating the schematic configuration of a network management function equipped packet transmission device 70 that is a packet transmission device equipped with a network management function.

First, the network management function equipped packet transmission device 70 includes a plurality of network interface modules 11, a switching module 12, and a control module 13 as similar to the packet transmission device 10 described above. Moreover, a software processing unit 18 in the control module 13 includes a packet transmission unit 19, a device information management unit 21, and an operation and management unit 23 as similar to the packet transmission device 10.

Then, the network management function equipped packet transmission device 70 according to this embodiment further includes the function of the network management unit 34 included in the network management device 50 according to the first embodiment. The network management unit 34 is an application that operates as a front end to manage the network management function equipped packet transmission device 70 itself and a packet transmission device 10, including a packet transmission device data collecting unit 35, a virtual network topology management unit 36, a computing device location management unit 37, a user interface unit 38, a virtual network topology table 39, a MAC learning database 41, and a converted MAC learning database 42.

In this embodiment, the packet transmission device data collecting unit 35 creates an information acquisition request message according to a request from the virtual network topology management unit 36 and the computing device location management unit 37, and sends the message to the operation and management unit 23 of the device of the packet transmission device data collecting unit 35 and an operation and management unit 23 of another packet transmission device 10 connected to a network. The content of the information acquisition request includes information such as the configuration of the packet transmission device 10 and the MAC address learned by the packet transmission device 10, for example. The detail of the process for acquiring information will be described later. When the packet transmission device data collecting unit 35 acquires a desired item of information, the packet transmission device data collecting unit 35 transfers the information to the virtual network topology management unit 36 and the computing device location management unit 37.

The virtual network topology management unit 36 extracts information about the topology of the virtual network from the configuration of the device of the virtual network topology management unit 36 and the configurations of the packet transmission devices 10 obtained through the packet transmission device data collecting unit 35, and creates a virtual network topology table 39. This virtual network topology table 39 finds the connection relationship between the entire virtual networks, and the topologies of the entire virtual networks can be identified. The user interface unit 38 can present the identified topologies of the virtual networks. Thus, a network administrator can confirm the topologies of the virtual networks.

On the other hand, the computing device location management unit 37 acquires a MAC learning table 25 of the device of the computing device location management unit 37 and MAC learning tables 25 of all the packet transmission devices 10 that are management subjects through the packet transmission device data collecting unit 35, and creates a MAC learning database 41. Moreover, the computing device location management unit 37 creates a converted MAC learning database 42 that the content of the MAC learning database 41 is sorted by every packet transmission port. These items of information enable the identification of computing devices connected to the virtual networks and the estimation of the locations of the computing devices. The user interface unit 38 can present the estimated locations of the computing devices. Thus, the network administrator can confirm the locations of the computing devices connected to the virtual networks.

In this embodiment, the user interface unit 38 displays a GUI (Graphical User Interface) for managing the packet transmission device on a display 46, and accepts various instructions from the network administrator.

FIG. 14 is a sequence diagram illustrating a process flow when the network management function equipped packet transmission device 70 according to the third embodiment requests the network management function equipped packet transmission device 70 itself and the packet transmission device 10 to acquire information. In convenience of illustration, the device information management unit 21 exists in the packet transmission device 10. However, in this embodiment, it is without saying that the processes of a request and a reply are similarly made with the device information management unit 21 in the network management function equipped packet transmission device 70 illustrated in FIG. 13.

When the device information management unit 21 receives a packet, the device information management unit 21 looks up the source MAC address of the packet, and records the source MAC address together with a packet transmission port number at which the packet is received on the MAC learning table 25. FIG. 6 is a diagram illustrating the MAC learning table 25 of the packet transmission device 10a. In the case of FIG. 6, it is shown that a packet having a source MAC address “aa:bb . . . ” is received at a packet transmission port number “0/2” (701). In this reception, the packet transmission device 10 records a VLAN identifier associated with the packet transmission port number as additional information. Moreover, the packet transmission device 10 updates an aging timer (time to delete a MAC address from the memory) every time when learning a MAC address, and also records the counts of aging timer updates within a predetermined time period as additional information. In the case of FIG. 6, the packet transmission device 10 records a VLAN identifier “10” and a count of aging timer updates “5” as additional information on the entry (Step S101). The virtual network topology management unit 36 in the network management function equipped packet transmission device 70 issues an acquisition request for configuration information to the virtual network topology management unit 36 itself and the packet transmission device 10 at regular time intervals (Step S102). The acquisition request is delivered to the device information management unit 21 in the packet transmission device 10. The device information management unit 21 creates a message in which the content of a configuration 24 is described, and sends a reply to the network management function equipped packet transmission device 70 (Step S103). When the virtual network topology management unit 36 receives the configuration of the packet transmission device from the reply, the virtual network topology management unit 36 extracts information about a virtual packet transmission device identifier, a VLAN identifier, and a packet transmission port number from the configuration, and writes the information on the virtual network topology table (Step S104). FIG. 7 is a diagram illustrating a created virtual network topology table 39.

The computing device location management unit 37 in the network management function equipped packet transmission device 70 also issues an acquisition request for the MAC learning table 25 to the computing device location management unit 37 itself and the packet transmission device 10 at regular time intervals (Step S105). The acquisition request is delivered to the device information management unit 21 in the packet transmission device 10. The device information management unit 21 creates a message in which the content of the MAC learning table 25 is described, and sends a reply to the network management function equipped packet transmission device 70 (Step S106).

When the computing device location management unit 37 receives information about the MAC learning table 25 from the reply, the computing device location management unit 37 extracts a MAC address, a packet transmission port number at which the MAC address is learned, a VLAN identifier associated with the packet transmission port, and a count of aging timer updates from the information, and writes them on the MAC learning database 41 (Step S107). FIG. 8 is a diagram illustrating a created MAC learning database 41.

The computing device location management unit 37 creates a converted MAC learning database 42 that the MAC learning database 41 in FIG. 8 is sorted by every packet transmission port (Step S108). FIG. 9 is a diagram illustrating the created converted MAC learning database 42.

The computing device location management unit 37 looks up the virtual network topology table 39 in FIG. 7, the MAC learning database 41 in FIG. 8, and the converted MAC learning database 42 in FIG. 9 to estimate a virtual network to which a computing device belongs and the location of the computing device in the virtual network.

As described above, the procedures to acquire information about another packet transmission device 10 connected to the network by the network management function equipped packet transmission device 70 are described as the third embodiment. The procedures to identify the topology of a virtual network and estimate the location of the computing device in the virtual network based on the acquired information conform to the first and second embodiments. In the network management system according to the third embodiment, such effect is exerted that it is unnecessary to dispose an exclusive network management device on the network and the hardware configuration of the system can be reduced in weight.

As described above, various embodiments of the present invention are described. However, the present invention is not limited to the foregoing embodiments, and includes various exemplary modifications and alterations. For example, the foregoing embodiments are described in detail for easily understanding the present invention. The present invention is not limited to ones including all the configurations described above. Moreover, a part of the configuration of a certain embodiment can be replaced by the configurations of the other embodiments. Furthermore, the configuration of a certain embodiment can be added with the configurations of the other embodiments. In addition, a part of the configurations of the embodiments can be added with, deleted, and replaced by the other configurations. Moreover, the present invention can be configured as a network management method and a computer program in addition to the configurations of the packet transmission device and the network management system described above.

Furthermore, the foregoing configurations, functions, processing units, processing modules, and so on may be entirely or partially implemented by hardware as by designing them with an integrated circuit, for example. In addition, the foregoing configurations, functions, and so on are described as an example that they are implemented by software by running a program to implement the functions. However, information such as a program, table, file or the like to implement the functions can be stored in a memory as well as a recording device such as a hard disk and an SSD (Solid State Drive), or a recording medium such as an IC card, SD card, and DVD, and can also be downloaded and installed via a network or the like as necessary.

According to the description of the present specification as described above, the description includes various aspects in addition to the appended claims. The following is the examples.

There is provided a network management system that manages a plurality of packet transmission devices, including a packet transmission device data collecting unit that looks up information about the packet transmission device via a network, a virtual network topology management unit that extracts a virtual packet transmission device identifier, a VLAN identifier, and a packet transmission port number from the acquired information and manages the topology of a virtual network, a virtual network topology table that stores the topology of the virtual network, a computing device location management unit that extracts a

MAC address, a VLAN identifier, and a packet transmission port number from the acquired information and manages the location of a computing device, and a MAC learning database that stores a list of the MAC address, the VLAN identifier, and the packet transmission port number. The virtual network topology table is looked up using the VLAN identifier recorded in a pair as a search key for every MAC address in the MAC learning database, and the virtual network identifier is searched to identify the virtual network to which the computing device having the MAC address belongs. Moreover, the MAC learning table is looked up using the MAC address as a search key, the packet transmission device having the largest count of aging timer updates is searched to estimate the packet transmission device close to the computing device, and the topology of the virtual network and the location of the computing device in the virtual network are drawn on the screen of a display of the network management system.

Moreover, there is provided the network management system, including a MAC learning database that stores the list of the MAC address, the VLAN identifier, and the packet transmission port number, and a converted MAC learning database that the MAC learning table is sorted by every packet transmission port. In the network management system, the virtual network topology table is looked up using the VLAN identifier recorded in a pair as a search key for every MAC address in the MAC learning database, and the virtual network identifier is searched to identify the virtual network to which the computing device having the MAC address belongs. Moreover, the converted MAC learning database is looked up using the packet transmission port number recorded in a pair as a search key, a packet transmission device with the smallest number of the learned MAC addresses is searched to estimate the packet transmission device close to the computing device, and the topology of the virtual network and the location of the computing device in the virtual network are drawn on the screen of a display of the network management system.

Furthermore, there is provided a network management computing device that manages a plurality of packet transmission devices, including a packet transmission device data collecting unit that looks up information about the packet transmission device via a network, a virtual network topology management unit that extracts a virtual packet transmission device identifier, a VLAN identifier, and a packet transmission port number from the acquired information and manages the topology of a virtual network, a virtual network topology table that stores the topology of the virtual network, a computing device location management unit that extracts a MAC address, a VLAN identifier, and a packet transmission port number from the acquired information and manages the location of the computing device, and a MAC learning database that stores a list of the MAC address, the VLAN identifier, and the packet transmission port number. The virtual network topology table is looked up using the VLAN identifier recorded in a pair as a search key for every MAC address in the MAC learning database, and the virtual network identifier is searched to identify the virtual network to which the computing device having the MAC address belongs. Moreover, the MAC learning table is looked up using the MAC address as a search key, the packet transmission device having the largest count of aging timer updates is searched to estimate the packet transmission device close to the computing device, and the topology of the virtual network and the location of the computing device in the virtual network are drawn on the screen of a display of the network management computing device.

In addition, there is provided the network management computing device, including a MAC learning database that stores the list of the MAC address, the VLAN identifier, and the packet transmission port number, and a converted MAC learning database that the MAC learning table is sorted by every packet transmission port. In the network management computing device, the virtual network topology table is looked up using the VLAN identifier recorded in a pair as a search key for every MAC address in the MAC learning database, and the virtual network identifier is searched to identify the virtual network to which the computing device having the MAC address belongs. Moreover, the converted MAC learning database is looked up using the packet transmission port number recorded in a pair as a search key, a packet transmission device with the smallest number of the learned MAC addresses is searched to estimate the packet transmission device close to the computing device, and the topology of the virtual network and the location of the computing device in the virtual network are drawn on the screen of a display in the network management computing device.

1. A network management system of a network connected with a plurality of packet transmission devices that construct a virtual network and a plurality of physical computing devices that operate a virtual computing unit, the network management system comprising:
a network management unit and a display,
wherein the network management unit collects information from the packet transmission devices, estimates the virtual network to which the virtual computing unit is connected and a location of the computing device in the virtual network based on the collected information, and displays a topology of the virtual network and the virtual computing unit connected to the virtual network on the display.

2. The network management system according to claim 1,
wherein the network management unit collects transfer history information about a packet of the packet transmission devices as the information, and compares the collected transfer history information to estimate the virtual network to which the virtual computing unit is connected and a location of the virtual computing unit in the virtual network.

3. The network management system according to claim 1, wherein:
the network management unit includes:
a packet transmission device data collecting unit configured to acquire the information about the packet transmission device via the network;
a virtual network topology management unit configured to extract a configuration of the virtual packet transmission device from the acquired information and manage a topology of the virtual network configuration;
a virtual network topology table configured to store the topology of the virtual network;
a computing device location management unit configured to extract transfer history information about a packet from the acquired information and manage a location of the computing device connected to the network; and
a transfer history database configured to store the transfer history information; and
the computing device location management unit identifies the virtual network to which the computing device belongs based on the virtual network topology table and the transfer history database, and estimates the packet transmission device close to the computing device.

4. The network management system according to claim 1,
wherein one of the plurality of packet transmission devices includes the network management unit and the display.

5. The network management system according to claim 1, further comprising a network management device connected to the network,
wherein the network management device includes the network management unit and the display.

6. A network management device that manages a network connected with a plurality of packet transmission devices that construct a virtual network and a plurality of physical computing devices that operate a virtual computing unit, the network management device comprising:
a processing unit and a storage unit,
wherein the processing unit collects information from the packet transmission devices, estimates the virtual network to which the virtual computing unit is connected and a location of the computing device in the virtual network based on the collected information, and outputs a topology of the virtual network and the location of the virtual computing unit connected to the virtual network.

7. The network management device according to claim 6,
wherein the processing unit collects transfer history information about a packet of the packet transmission devices as the information, and compares the collected transfer history information to estimate the virtual network to which the virtual computing unit is connected and a location of the virtual computing unit in the virtual network.

8. The network management device according to claim 6, wherein:
the processing unit includes:
a packet transmission device data collecting unit configured to acquire the information about the packet transmission device via the network;
a virtual network topology management unit configured to extract a configuration of the virtual packet transmission device from the acquired information and manage a topology of the virtual network; and
a computing device location management unit configured to extract transfer history information about a packet from the acquired information and manage a location of the computing device connected to the network;
the storage unit includes:
a virtual network topology table configured to store the topology of the virtual network; and
a transfer history database configured to store the transfer history information; and
the computing device location management unit identifies the virtual network to which the computing device belongs based on the virtual network topology table and the transfer history database, and estimates the packet transmission device close to the computing device.

9. The network management device according to claim 8, wherein:
the virtual network topology table stores a virtual network identifier, a virtual packet transmission device identifier, a VLAN identifier, and a packet transmission port number; and
the transfer history database stores a MAC address, a VLAN identifier, and a packet transmission port number for every packet transmission device.

10. The network management device according to claim 9, wherein:
the computing device location management unit looks up the virtual network topology table using the VLAN identifier stored as paired with the MAC address as a search key for the individual MAC addresses stored in the transfer history database, and identifies the virtual network identifier to which the computing device having the MAC address as a source belongs; and
the computing device location management unit looks up the transfer history database using the packet transmission port number stored as paired with the MAC address as a search key, and estimates the packet transmission device close to the computing device having the MAC address as a source.

11. The network management device according to claim 10, wherein:
the transfer history database stores a count of aging timer updates that is updated every time when the packet transmission device learns the MAC address; and
the computing device location management unit estimates the packet transmission device having a maximum value of the count of aging timer updates as a packet transmission device close to the computing device.

12. The network management device according to claim 10,
wherein the computing device location management unit estimates the packet transmission device having a smallest number of the MAC addresses learned at the packet transmission port as a packet transmission device close to the computing device from a combination of the packet transmission device and the packet transmission port in the transfer history database.

13. The network management device according to claim 6, further comprising a display,
wherein the display displays a topology of the virtual network and a location of the virtual computing unit connected to the virtual network.

14. The network management device according to claim 8, further comprising a display,
wherein the display displays a topology of the virtual network and a location of the computing device connected to the virtual network.

15. The network management device according to claim 8, further comprising a display,
wherein the display displays a topology of the virtual network and a location of the virtual computing unit connected to the virtual network.
